(19) United States
(12) Patent Application Publication
(10) Pub. No.: US 2006/0182631 A1
(43) Pub. Date: Aug. 17, 2006

(54) Lifting stage

(75) Inventors: Roland Seifert, Kassel (DE); Claus Kress, Neckargemuend (DE)

Correspondence Address: DAVIDSON, DAVIDSON & KAPPEL, LLC, 485 SEVENTH AVENUE, 14TH FLOOR, NEW YORK, NY, 10018, US

(73) Assignee: Leica Microsystems CMS GmbH, Wetzlar (DE)

(21) Appl. No.: 11/332,102

(22) Filed: Jan. 16, 2006

Related U.S. Application Data
(60) Provisional application No. 60/749,714, filed on Dec. 13, 2005.

(30) Foreign Application Priority Data
Jan. 17, 2005 (DE) 10 2005 002 309.6

(51) Int. Cl. B64C 27/605

(52) U.S. Cl. 416/114

(57) ABSTRACT

A lifting stage includes a carrier frame, an object plate configured to carry an object, a cross-member, and a parallel articulation arrangement configured to articulate the object plate to the carrier frame so that the object plate is capable of being raised or lowered relative to the carrier frame without tilting. The parallel articulation arrangement includes a number of parallel articulations and connects the cross-member to the carrier frame and the cross-member to the object plate.

Priority is claimed to the provisional application entitled “Elevating Platform,” filed by applicants on Dec. 13, 2005, and to German patent application DE 10 2005 002 309.6, filed on Jan. 17, 2005, the entire subject matters of both of which are hereby incorporated by reference herein.

The present invention relates to a lifting stage, especially for use as a focusing stage for a microscope, comprising a carrier frame and an object plate that is articulated onto the carrier frame and that carries the object, whereby the object plate is articulated onto the carrier frame by means of a parallel articulation arrangement and it can be raised or lowered relative to the carrier frame without tilting.

The invention relates to a lifting stage in general that can be used for all kinds of purposes. In particular, this pertains to tilt-free raising or lowering objects of any kind. An area of application is its use as a focusing stage for a microscope. For the sake of simplicity, reference will be made hereinafter to this concrete application.

### BACKGROUND

In regular microscopy, the focus position of the object is adjusted by means of the focusing drive of the microscope. The positioning precisions that can be achieved with the motors installed there—as a rule DC motors—lie at ±50 nm. Such values, however, are too inadequate by more than a factor of two, so that such focusing techniques cannot be used. Frequently, external stepping motors are also flanged onto the fine focusing drive of the microscope. Appropriate gear reductions can then achieve fine increments, but the possibility to freely position external or internal gears is quite severely restricted.

Such gear-free direct drives are already known in actual practice. Such direct drives can achieve positioning precisions in the range of nanometers. However, the available travel distance is limited to a few hundred micrometers. An additional problem is that such a direct drive only moves one objective at a time, which then projects far beyond the other objectives.

Piezoactively movable Z-stages are likewise known in actual practice. The travel ranges of such Z-stages are limited by the piezoelectric elements. Moreover, piezoelectric systems are expensive due to the requisite external measuring systems and the likewise needed high-voltage control mechanisms. Almost any desired Z-scanning rate can be achieved with piezoelectric control. Uniformly fast and also very slow Z-scanning rates, for example, 1000 μm per second to 0.01 μm per second may be achievable. In any case, speed tolerances of less than±0.5%, however, are extremely difficult to achieve with gear-motor means.

Z-stages with a galvanometrically driven tilting plate have been known in actual practice for years. The drawback of such an arrangement, however, lies in the fact that, in the case of large lifting movements, the object inevitably moves laterally when it is lifted. If the object being observed is in the plane of the fulcrum of the tilting plate, then the error that occurs due to the lateral movement is negligibly small. In the case of objects or object areas that are further away from the plane of the fulcrum, however, this error quickly becomes unacceptably large as the distance increases.

German Published Examined Application No. 20 53 020 describes a precision objective stage for an optical microscope. The object plate that carries the object is arranged there inside a frame and can be adjusted perpendicularly relative to the frame for fine adjustment purposes. In order to be able to execute the requisite lifting movement of the object plate, the latter is supported on the frame by a total of four strap hinges. By means of a drive, the object plate can be moved perpendicularly relative to the frame, whereby the extent of this movement or shifting is prescribed by the length and elasticity of the strap hinges. In order to ensure a uniform lifting movement of the object plate—without tilting of the object plate—a complex adjustment mechanism is provided that uses levers and pressure parts arranged below the object plate to lift the object plate synchronously on both sides, namely, within the scope of the lifting movement that is possible by means of the strap hinges. The drive needed to execute the parallel lifting is complex and requires a great deal of space.

U.S. Pat. No. 4,893,914 describes a testing station for semiconductor chips or the like, said testing station comprising a microscope as well as a fine focusing stage with an object plate that carries the object. The object plate is shaped like a dish and can be moved vertically by means of a cylindrical guide. A tilting error of the object plate is unavoidable due to the play that inevitably exists in the guide.

East German patent application 02 24 415 A1 shows a device for lifting an object to a reference plane, said device being employed in optical devices. The object rests on levers that are pivoted for rotational movement and it is lifted to the reference plane by means of mechanical coupling links of lifting systems that function independently of each other. Two lifting systems that are independent of each other lift a carrier plate with a bearing arranged in the center. A two-sided lever arranged there acts directly on the object or the object plate via supports arranged in the corner areas and said object plate, in turn, moves against stops. The object or the object plate is unavoidably tilted there until the object comes to rest on the stops. If one were to wish to avoid a tilting of the object or of the object plate during the vertical lifting, the two drives that function independently of each other would have to be synchronized and the object and the object plate or the carrier plate would have to be guided tilt-free. This calls for a complex construction.

German patent no. 196 50 392 C2 describes a generic lifting stage in which a parallel articulation arrangement is provided. The parallel articulations concurrently form the frame so that a fairly unstable construction is obtained. Furthermore, only an extremely small area remains available for holding the object plate, so that articulating onto a frame, especially onto a microscope, is problematic due to the lack of a sufficiently large support surface. Moreover, with the prior-art lifting stage, the parallel articulation arrangement extends beyond the entire area of the object plate, so that a free space on virtually all sides is needed in order to raise and lower the lifting stage. Finally, the generic lifting stage entails a very specific problem in that a direction component in the Y-direction ensues as a result of the parallel articulation arrangement implemented there, so that there is at least a slight offset in the Y-direction corresponding to the rotation executed in the articulation when the object plate is raised and lowered. This is especially problematic from the standpoint of microscopy.

### SUMMARY OF THE INVENTION

The present invention is based on the objective of configuring and refining the generic lifting stage in such a way that no offset of the object plate occurs either in the X-direction or in the Y-direction.

The present invention provides a lifting stage including a carrier frame and an object plate that is articulated onto the carrier frame and that carries the object, whereby the object plate is articulated onto the carrier frame by means of a parallel articulation arrangement and it can be raised or lowered relative to the carrier frame without tilting. The parallel articulation arrangement includes parallel articulations that connect a cross-member to the carrier frame and the cross-member to the object plate.

According to the invention, it has been realized that a lifting stage of the generic type, which is also especially suitable as a fine focusing stage for a microscope, can be fitted with simple structural means in such a way as to prevent or compensate for an offset in the Y-direction relative to the object plate that carries the object. For this purpose, very special parallel articulations are provided, whereby the parallel articulations connect a cross-member to the carrier frame and the cross-member to the object plate. In other words, the parallel articulations engage the rigid carrier frame, which is independent of the parallel articulations, so that the cross-member is connected to the carrier frame via the parallel articulations. In turn, the object plate is articulated onto the cross-member, namely, likewise via parallel articulations, so that the parallel articulation arrangement comprises two groups of parallel articulations. A Y-offset of the one group of parallel articulations is compensated for by the Y-offset of the other group of parallel articulations, so that the object plate is not subjected to a Y-offset relative to the carrier frame when it is raised and lowered.

In an advantageous manner, the parallel articulation arrangement comprises two pairs of parallel articulations, whereby the one pair of parallel articulations connects the cross-member to the carrier frame and the other pair of parallel articulations connects the cross-member to the object plate. Consequently, the carrier frame is configured rigidly and independently of the parallel articulation arrangement, and the parallel articulation arrangement extends from the carrier frame, also encompassing the cross-member between the carrier frame and the object plate, resulting in an especially stable configuration. Hence, the parallel articulation arrangement encompassing the cross-member is responsible for the lifting movement, whereby the cross-member serves to change the direction in the Y-direction so as to compensate for the Y-direction components of both pairs of parallel articulations in an ideal manner. When both pairs of parallel articulations are deflected in the same way, the circular movements in the bending points are the same so that a compensation in the Y-direction is achieved with simple means.

In another advantageous manner, the parallel articulations are arranged and configured in such a way that the one pair forms outer parallel articulations and the other pair forms inner parallel articulations. Here, it is also advantageous for the parallel articulations to be arranged in pairs next to each other, whereby rigid frame parts of the carrier frame can extend between the parallel articulations. This, once again, greatly enhances the stability of the arrangement.

To be more precise, the outer parallel articulations connect the cross-member to the carrier frame and the inner parallel articulations connect the cross-member to the object plate. A reverse arrangement is likewise conceivable, in which the inner parallel articulations connect the cross-member to the carrier frame and the outer parallel articulations connect the cross-member to the object plate.

Within the scope of an embodiment with two pairs of parallel articulations, it is also advantageous for these pairs of parallel articulations to be arranged on one side of the carrier frame so that the carrier frame with its rigid constituents surrounds the object plate as a structural unit on at least three sides. However, it is likewise conceivable for the pairs of parallel articulations to be arranged on opposite sides of the carrier frame or to extend—preferably laterally—from one side to the other side of the carrier frame.

The parallel articulations can be configured in such a way that they extend at least in pairs parallel to each other, whereby—as already mentioned above—rigid frame parts can be arranged between them. Due to the parallel arrangement, the axes of rotation of the parallel articulations all run parallel to each other, so that a compensation of the Y-offset is achieved in an especially simple manner.

A compensation of the Y-offset is also enhanced in that the parallel articulations are arranged in such a way that they bend in pairs in opposite directions when the object plate is raised or lowered, namely, on the one hand, relative to the carrier frame in the direction of the carrier frame and on the other hand, relative to the cross-member in a direction that is opposite to the first direction of rotation, that is to say, away from the carrier frame. The rotation causes the Y-offset being formed towards the carrier frame to be compensated for relative to the cross-member by a corresponding Y-offset in the opposite direction.

In an advantageous manner, the parallel articulations are configured as so-called solid articulations, that is to say, they are parallel articulations with defined bending points and not, for instance, with hinges or the like. Such an embodiment has the advantage that these articulations function without play, while the object plate moves—without Y-offset—parallel to the carrier frame. A direction component in the X-direction fundamentally does not occur due to the solid articulations.

Within the scope of an embodiment, each parallel articulation has two legs that run parallel to each other and that are directly or indirectly connected on both sides via bending points to the carrier frame, to the cross-member and to the object plate. When the object plate is raised or lowered relative to the carrier frame, tapered areas in the bending points bend, whereby the legs of each parallel articulation move parallel to each other. As a result, the position of the object plate is stable relative to the carrier frame, namely, in a parallel arrangement. Thus, the object plate can be raised and lowered tilt-free, without the occurrence of a Y-offset of the object plate, i.e. a Y-offset of the object plate relative to the carrier frame.

Moreover, it is conceivable for the legs of the parallel articulations to each connect via the bending points to a bearing block that is associated with or connected to the appertaining components—carrier frame, object plate or cross-member. Therefore, the bearing block serves to connect the parallel articulations—via their bending points—to the appertaining component.

In another advantageous manner, the parallel articulations of at least one of the pairs are configured identically. In order for a compensation of an offset in the Y-direction to actually take place, it is also advantageous for the parallel articulations of both pairs to be configured identically. Mechanisms for gearing up or gearing down are then not necessary.

Within the scope of the features explained above, it is practical for the object plate to be almost entirely integrated into the carrier frame. This means that the carrier frame essentially surrounds the object plate on three sides, so as to permit a secure arrangement on a stand and a fixation of the entire arrangement. The object plate is to be understood more or less as a cutout from the carrier frame, whereby this cutout can be lowered and/or raised relative to the carrier frame, namely, merely by executing a movement in the Z-direction. A direction component in the X-direction does not occur, whereas a direction component in the Y-direction is compensated for owing to the special arrangement of the parallel articulations.

In another advantageous manner, the object plate comprises a receiving element for specimens or for a specimen holder. By the same token, it is conceivable for the object plate to comprise a receiving element for specimens or a specimen holder as integral components.

If the lifting stage functions as a focusing stage for a microscope, it could be used to work in incident light or transmitted light. In order to achieve transmitted light applications, the object plate is formed with a preferably centered opening, whereby this is provided in the area of the receiving element for specimens or in the area of the specimen holder.

In order to raise or lower the object plate, in another advantageous manner, a drive is provided, whereby this can fundamentally be a manually operated mechanical drive. The drive can be configured as a single-stage or multi-stage drive. In an advantageous manner, the drive is a galvanometer drive that is also especially well-suited for fine adjustment.

As far as the structure is concerned, it is especially advantageous for the drive—preferably with its rigid part—to be supported on a stand or on the carrier frame and to act with its driven part against the cross-member or the object plate. This drive can be configured in such a way that it either presses the object plate in the direction of movement or pulls the object plate in the direction of movement. As far as possible drives are concerned, mention should be made of the state of the art described in depth above, which explains the different types of drives and mechanisms for use with the lifting stage according to the invention.

### BRIEF DESCRIPTION OF THE DRAWINGS

Various possibilities exist to configure and refine the teaching of the present invention in an advantageous manner. Reference is made to the explanation below of a preferred embodiment of the invention on the basis of the drawings. In conjunction with the explanation of the preferred embodiment of the invention on the basis of the drawings, generally preferred embodiments and refinements of the teaching will also be explained. The drawings show the following:

FIG. 1 a schematic view of a first embodiment of a lifting stage according to the invention; and

FIG. 2 the lifting stage of FIG. 1 in a schematic side view.

### DETAILED DESCRIPTION

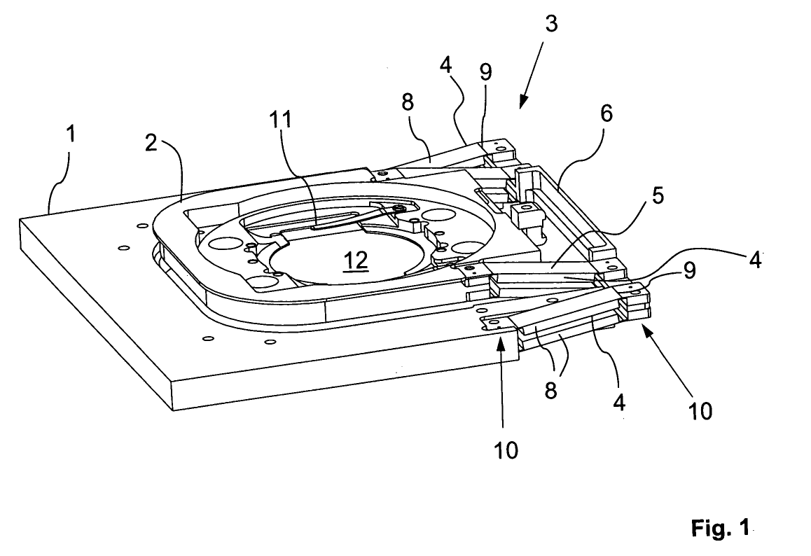

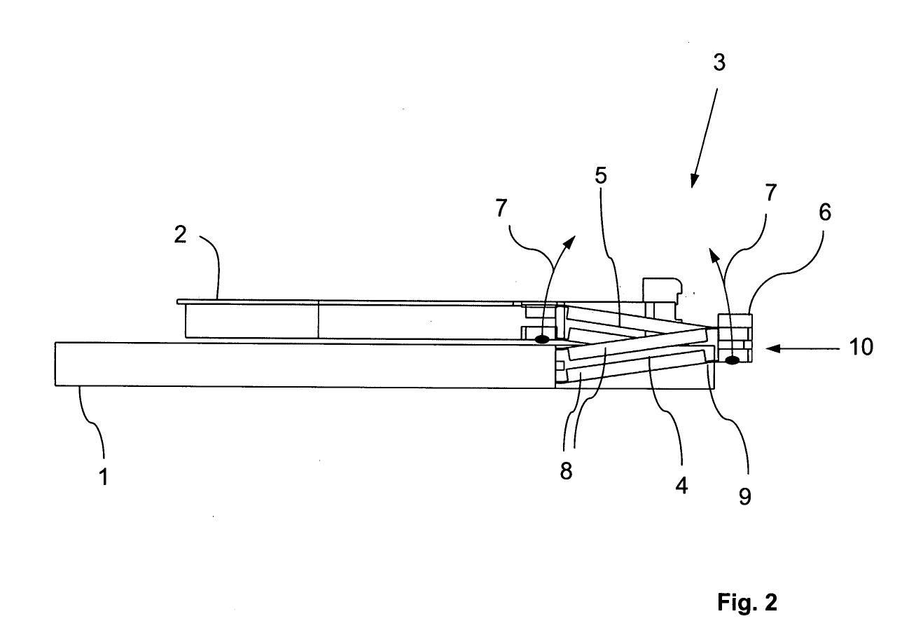

FIGS. 1 and 2 together show an embodiment of a lifting stage according to the invention that is suitable as a focusing stage for a microscope. The lifting stage comprises a carrier frame 1 and an object plate 2 that is articulated onto the carrier frame 1 and that carries the object. The object plate 2 is articulated onto the carrier frame 1 via a parallel articulation arrangement 3 and can be raised or lowered relative to the carrier frame 1 without tilting.

In the manner according to the invention, the parallel articulation arrangement 3 comprises individual parallel articulations 4, 5, whereby the parallel articulations 4 connect a cross-member 6 to the carrier frame 1 and the parallel articulations 5 connect the cross-member 6 to the object plate 2. Owing to such an arrangement, with the insertion of the cross-member 6, it is possible to compensate for direction components in the Y-direction, so that the object plate 2 can be raised and lowered only in the Z-direction relative to the carrier frame 1.

FIGS. 1 and 2 also show that the parallel articulation arrangement 3 comprises two pairs of parallel articulations 4 and 5, whereby the one pair of parallel articulations 4 connects the cross-member 6 to the carrier frame 1 and the other pair of parallel articulations 5 connects the cross-member 6 to the object plate 2.

FIG. 1 shows especially clearly that the one pair forms outer parallel articulations 4 and the other pair forms inner parallel articulations 5.

The pairs of parallel articulations 4, 5 are arranged on the same side of the carrier frame 1, whereby the parallel articulations 4 extend in a pair parallel to each other, and whereby the pair of parallel articulations 5 likewise run parallel to each other.

The arrows 7 drawn in FIG. 2 indicate that the parallel articulations 4, 5 are configured and arranged in such a way that they bend in pairs in opposite directions, whereby the arrows 7 show the circular movement of a point on the specimen plane and on an intermediate plane of each parallel articulation.

Each of the parallel articulations 4, 5 comprises two legs 8 that run parallel to each other and that are connected on both sides via bending points 9 to the carrier frame 1, to the cross-member 6 and to the object plate 2. When the bending points 9 bend, the legs 8 move parallel to each other. Moreover, the legs 8 of the parallel articulations 4, 5 are connected via the bending points 9 to a bearing block 10 that is associated with or connected to the appertaining components.

The figures also show that the parallel articulations 4, 5 are configured identically so that a compensation of the movement component in the Y-direction is achieved with simple means.

The figures also show that the carrier frame 1 essentially surrounds the object plate 2 on three sides, whereby the object plate 2 is configured as a kind of cutout from the carrier frame 1.

The object plate 2 also comprises a receiving element 11 for specimens or specimen holders. Moreover, the object plate 2 has an opening 12 in the center for transmitted light applications.

With respect to a drive, reference is hereby made to the general part of the description in order to avoid repetition.

Finally, it should be pointed out explicitly that the embodiment described above merely serves for purposes of elucidating the teaching being claimed but that the later should not be construed as being restricted to this embodiment.

What is claimed is:

1. A lifting stage comprising:
a carrier frame;
an object plate configured to carry an object;
a cross-member; and
a parallel articulation arrangement configured to articulate the object plate to the carrier frame so that the object plate is capable of being raised or lowered relative to the carrier frame without tilting, the parallel articulation arrangement including a plurality of parallel articulations and connecting the cross-member to the carrier frame and the cross-member to the object plate.

2. The lifting stage as recited in claim 1 wherein the object plate is disposed in a microscope so as to provide a focusing stage for the microscope.

3. The lifting stage as recited in claim 1 wherein the plurality of parallel articulations includes a first pair of parallel articulations connecting the cross-member to the carrier frame and a second pair of parallel articulations connecting the cross-member to the object plate.

4. The lifting stage as recited in claim 3 wherein the first pair of parallel articulations forms outer parallel articulations and the second pair of parallel articulations forms inner parallel articulations.

5. The lifting stage as recited in claim 3 wherein the first pair of parallel articulations forms inner parallel articulations and the second pair of parallel articulations forms outer parallel articulations.

6. The lifting stage as recited in claim 3 wherein the first and second pairs of parallel articulations are disposed on a same side of the carrier frame.

7. The lifting stage as recited in claim 3 wherein the first and second pairs of parallel articulations are disposed on opposite sides of the carrier frame.

8. The lifting stage as recited in claim 1 wherein the plurality of parallel articulations extend in at least pairs of articulations parallel to each other.

9. The lifting stage as recited in claim 1 wherein the plurality of parallel articulations are disposed in at least a first and second pair so that the first and second pairs bend in opposite directions.

10. The lifting stage as recited in claim 1 wherein the plurality of parallel articulations include a plurality of solid articulations.

11. The lifting stage as recited in claim 1 wherein each of the plurality of parallel articulations includes a first pair of parallel articulations each having a first pair of parallel legs and a second pair of parallel articulations each having a second pair of parallel legs, the first pair of parallel legs being connected, via respective first bending points, at first ends thereof to the carrier frame and at second ends thereof to the cross-member, the second pair of parallel legs being connected, via respective second bending points, at first ends thereof to the object plate and at second ends thereof to the cross-member.

12. The lifting stage as recited in claim 11 wherein the first pairs of parallel legs move parallel to each other when the first bending points bend, and the second pairs of parallel legs move parallel to each other when the second bending points bend.

13. The lifting stage as recited in claim 11 wherein:
each of the first pair of parallel legs is connected, via the respective first bending points, at the first ends thereof to a respective first bearing block associated with the carrier frame and at the second ends thereof to a respective second bearing block associated with the cross-member; and
each of the second pair of parallel legs is connected, via the respective second bending points, at the first ends thereof to a respective third bearing block associated with the object plate and at the second ends thereof to a fourth bearing block associated with the cross-member.

14. The lifting stage as recited in claim 12 wherein:
each of the first pair of parallel legs is connected, via the respective first bending points, at the first ends thereof to a respective first bearing block associated with the carrier frame and at the second ends thereof to a respective second bearing block associated with the cross-member; and
each of the second pair of parallel legs is connected, via the respective second bending points, at the first ends thereof to a respective third bearing block associated with the object plate and at the second ends thereof to a fourth bearing block associated with the cross-member.

15. The lifting stage as recited in claim 3 wherein the respective articulations of at least one of the first and second pair of parallel articulations are configured the same as each other.

16. The lifting stage as recited in claim 3 wherein the respective articulations of both the first and second pair of parallel articulations are configured the same as each other.

17. The lifting stage as recited in claim 1 wherein the carrier frame substantially surrounds the object plate on three sides of the object plate.

18. The lifting stage as recited in claim 1 wherein the object plate has dimensions of a cutout of the carrier frame.

19. The lifting stage as recited in claim 1 wherein the object plate includes a receiving element configured to receive a specimen or a specimen holder.

20. The lifting stage as recited in claim 1 wherein the object plate includes an opening.

21. The lifting stage as recited in claim 1 further comprising a drive supported on a stand or on the carrier frame and configured to act against at least one of the cross-member and the object plate.

22. The lifting stage as recited in claim 21 wherein the drive includes at least one of a single-stage and a multi-stage drive.

23. The lifting stage as recited in claim 21 wherein the drive includes a galvanometer drive.
